(19) United States
(12) Patent Application Publication
(10) Pub. No.: US 2005/0245655 A1
(43) Pub. Date: Nov. 3, 2005

(54) Rapid crystallizing poly(trimethylene terephthalate) compositions and processes

(76) Inventors: Donald Ross Kelsey, Fulshear, TX (US); Cecilia Zuqi Tse, Katy, TX (US); Edward James Denton, Richmond, TX (US); Kevin Dale Allen, Prairieville, LA (US); Emery Don Johnson, Houston, TX (US)

Correspondence Address: SHELL OIL COMPANY, P O BOX 2463, HOUSTON, TX, 772522463, US

(21) Appl. No.: 10/836,983

(22) Filed: Apr. 30, 2004

(51) Int. Cl. C08K 5/04

(52) U.S. Cl. 524/394

(57) ABSTRACT

Small amounts of one or more alkali or alkaline earth metal salts, particularly lithium or calcium salts, added to polytrimethylene terephthalate (PTT) have been found to greatly accelerate the crystallization rate of the polymer. Preferably, from about 1 to about 10 ppm of the alkali or alkaline earth metal, based on metal, is effective. For example, 7 ppm of Li⁺ can produce about 5-20 times faster crystallization, depending on the rate of cooling, compared to PTT without lithium. The rapid-crystallizing PTT compositions are preferably comprised of carboxylate salt endgroups, COOM, wherein M is an alkali or alkaline earth metal cation, preferably lithium or calcium cation. The metal salt is conveniently added to the polymerization process.

### FIELD OF THE INVENTION

This invention relates to a process of producing polytrimethylene terephthalate (PTT) with an intrinsic viscosity of at least 0.75 dl/g by esterification of terephthalic acid (TPA) with trimethylene glycol (TMG; this is also referred to as 1,3-propanediol, PDO) in the presence of a catalytic titanium compound to obtain an esterification product, precondensation of the product, and polycondensation of the precondensation product to obtain PTT.

### BACKGROUND OF THE INVENTION

Polytrimethylene terephthalate is a polyester useful in fiber applications in the carpet and textile industries. The manufacture of polytrimethylene terephthalate involves the condensation polymerization of 1,3-propanediol and terephthalic acid to a polymer having an intrinsic viscosity (hereafter referred to as IV) of about 0.4 to 1.0 dl/g. The polymer melt is discharged from the melt reactor and extruded through an extrusion die into strands. The strands are quenched in cold water and cut into pellets for storage or transportation. It has been found that polytrimethylene terephthalate pellets tend to adhere together, or block, during storage or shipping at temperatures above the polymer glass transition temperature Tg (about 45° C.), which temperature can easily be reached during storage in a silo, rail car, or hopper. Agglomeration of the pellets can also occur during drying.

### SUMMARY OF THE INVENTION

Small amounts of one or more alkali or alkaline earth metal salts, particularly lithium or calcium salts, added to polytrimethylene terephthalate (PTT) have been found to greatly accelerate the crystallization rate of the polymer. From about 0.01 to about 200 ppm, preferably about 1 to about 100, more preferably about 1 to about 50, and most preferably about 1 to about 10, of the alkali or alkaline earth metal, based on metal, is effective. For example, 7 ppm of Li⁺ can produce about 5-20 times faster crystallization, depending on the rate of cooling, compared to PTT without lithium. The rapid-crystallizing PTT compositions are preferably comprised of carboxylate salt endgroups, COOM, wherein M is an alkali or alkaline earth metal cation, preferably lithium or calcium cation. The metal salt is conveniently added to the polymerization process.

### DETAILED DESCRIPTION OF THE INVENTION

The processes to prepare the PTT compositions can be continuous, semi-batch or batch process in which the IV of the polymer prepared in the final melt stage is greater than 0.4, preferably greater than 0.8. Processes in which the PDO and TPA are fed together or separately to PTT oligomer melt in the first reaction stage, typically at an oligomer to feed weight ratio at any point during the feed addition of greater than about 0.1, are preferred. In the case of “zero heel” batch processes (U.S. Pat. No. 6,528,579), the oligomer to feed ratio may be zero or may start at zero at the beginning of the esterification and gradually increase. In the case of semi-batch and batch process, it is also desirable to add the feed gradually during the esterification stage and with an oligomer to feed weight ratio always greater than about 0.2. In the case of processes employing continuous esterification, the feed is, by definition, gradual and typically the oligomer to feed weight ratio is greater than 1, usually greater than 10, and most often greater than 100. Processes using dialkyl terephthalate, e.g. dimethyl terephthalate, can also be used. The process can employ solid-state polymerization to reach the final desired molecular weight or can be an “all-melt” process without the solid-state polymerization step.

It is preferred that the process described in U.S. Pat. No. 6,277,947, U.S. Pat. No. 6,326,456, U.S. Pat. No. 6,509,438, and U.S. Pat. No. 6,512,080, which are herein incorporated by reference, be used for making fast crystallization PTT according to this invention. The characteristic features of this process, which comprises the catalytic esterification of TPA with 1,3-propanediol (PDO), precondensation of the esterification product and polycondensation of the precondensation product, are as follows. The esterification is performed in at least 2 stages, one initial stage and at least one second, subsequent stage connected to a process column. The catalyst used for esterification and polycondensation preferably is a titanium compound, preferably in a stabilized liquid formulation, which is prepared from a catalytic titanium compound, an organic acid and PDO as solvent, in such way that the liquid catalyst feed contains less than 5 percent by weight (wt %) titanium. The catalyst used for esterification in the first, initial stage can be alternatively a Ti containing liquid reaction product from TPA and PDO with a degree of esterification of at least 97%, which may be recycled from a later reaction stage and fed to the initial esterification stage together with the raw materials.

A defined quantity of the described liquid catalyst feed is introduced into the first, initial esterification stage and separately a second defined quantity of the liquid catalyst feed is added to the at least one subsequent stage of esterification. A major quantity between 65 and 100 wt % of said liquid catalyst feed containing 35 to 110 ppm titanium may be introduced into the at least one subsequent esterification stage, which is operated at a temperature of 245 to 260° C. and a pressure of 0.7 to 1.5 bar. A minor quantity of said liquid catalyst feed containing 0 to 40 ppm titanium and up to 35% of the total catalyst may be directly fed to the initial esterification stage, which direct catalyst feed can be partially or completely substituted by the same quantity of catalyst in a reaction product, which may be recycled from any further reaction stages and which is mixed with the raw materials for further reaction in said initial esterification.

In the first, initial esterification stage a total molar feed ratio of PDO/TPA of 1.15 to 2.5, an amount of titanium of 0 to 40 ppm, which is in maximum 35% by weight of the total amount of catalyst, a temperature of 240 to 275° C. and an absolute pressure of 1 to 3.5 bar are adjusted, whereby the reaction is continued until 90 to 95% of the TPA is esterified. In the at least one subsequent esterification stage an additional amount of titanium of 35 to 110 ppm, which is 65 to 100% by weight of the total amount of catalyst, is added at a temperature of 245 to 260° C. and an absolute pressure of 0.7 to 1.5 bar, whereby the reaction is continued until 97 to 99% of the TPA is esterified.

The precondensation is performed at a temperature of 245 to 260° C. under a reduced pressure in the range from 2 to 200 mbar. The polycondensation is carried out in the melt phase at a temperature increasing from the entry to the exit of the polycondensation reactor from 250 to 270° C. and at an absolute pressure of 0.2 to 2.5 mbar.

During pilot plant scale syntheses of PTT based on the process described in U.S. Pat. No. 6,277,947, U.S. Pat. No. 6,326,456, U.S. Pat. No. 6,509,438, and U.S. Pat. No. 6,512,080, we discovered that addition of lithium hydroxide (LiOH) to the feed produced a PTT that crystallized at an accelerated rate compared to PTT prepared without LiOH. We were surprised to observe that the polymer strands became opaque during pelletizing before reaching the cutter and the pellets from the pelletizer cutter, likewise, were opaque. Normally, the PTT strands and pellets are transparent at this stage of the process.

Evaluations showed that the crystallinity of these opaque pellets, before being subjected to a crystallization step, was substantially higher than the crystallinity of the usual transparent pellets produced during pelletization. Differential scanning calorimetry (DSC) measurements confirmed the faster crystallization rate of the PTT prepared with LiOH. We were also surprised that a very low level (˜7 ppm based on polymer) of lithium ion produced this rapid crystallization. DSC measurements on several laboratory samples of PTT made with various additives also showed enhanced crystallization rates, particularly when LiOH, Li acetate, or Ca hydroxide were added at low concentrations.

The compositions and processes described herein allow better control of the crystallization rate of PTT. For example, PTT pellets must be crystallized to a degree sufficient to prevent sticking during subsequent handling or processing, e.g. for storage and transport, before drying or before solid-state polymerization. A rapid-crystallizing PTT allows such crystallization steps to be carried out more efficiently or eliminated altogether, which can simplify the overall process and reduce costs. Enhanced crystallization rate can improve or alter the processing of the PTT polymer or the performance and behavior of films, fibers, molded articles, and the like, produced therefrom.

Experimental

All-melt process. About 27 Kg of 1,3-propanediol (PDO) and 47.5 Kg of terephthalic acid (TPA) was charged to a feed vessel and stirred to make a paste slurry. To this slurry was added Ti butoxide catalyst in acetic acid/PDO solution (about 20 ppm Ti based on TPA), hindered phenol stabilizer Irganox 1076 (0.025% based on final polymer) and 0.5 ppm silicon-based antifoam agent. Optionally, cobalt acetate (typically 5-20 ppm Co based on TPA) was also added to improve the color of the polymer. The total PDO/TPA molar ratio charged to the esterification reactor was about 1.25. In the esterification stage, this paste mixture was added slowly over about 70 to 90 minutes to about 60 Kg of PTT oligomer prepared in the previous batch and heated at about 260° C. at near or just above atmospheric pressure. Water, PDO and byproducts were distilled off and, after a total of about 150 minutes, additional catalyst was added (about 60 ppm Ti based on TPA charged). The prepolymerization was conducted at about 255° C. in the same reactor by reducing the pressure gradually over 15-20 minutes to about 50 mbar and, after 30-40 minutes, approximately one-half of the reactor contents was transferred to the polycondensation reactor, a “disk ring” reactor designed to generate renewable high surface area, and the pressure was further reduced from about 450 mbar to <5 mbar. After about 170-200 minutes at about 255° C. when the intrinsic viscosity (IV) of the polymer had reached the desired value, the mixing was stopped and the melt polymer was discharged through a die using a melt pump into a strand pelletizing system wherein the melt streams were cooled in a water bath to form solid polymer strands that were fed to a pelletizer (cutter). The discharge/pelletizing step typically took 20-40 minutes to complete.

The solidified polymer strands and the pellets collected from the cutter were transparent and were fed to a hot water crystallization system for crystallization. Low-field NMR analysis of the pellets taken from the pelletizer typically measured a crystallinity of about 10%. After crystallization, the pellets were opaque and had a crystallinity of 29%. Low field NMR analysis has been correlated to crystallinity determined by pellet density.

PTT with added Li hydroxide. The polymerization process described above was conducted in a similar manner except that LiOH monohydrate was added to the paste feed to achieve a final concentration in the polymer of about 24 ppm LiOH or about 7 ppm Li ion.

When the PTT polymer prepared with LiOH was discharged from the reactor, the polymer strands became opaque during pelletizing before reaching the cutter and the pellets from the pelletizer cutter, likewise, were opaque. Low-field NMR analysis showed that the crystallinity of these pellets was about 27% even before being subjected to the hot water crystallizing step and much higher than the ˜10% crystallinity of the control batch (see above). After the crystallization step, the crystallinity was 31%

PTT with sodium phosphite (comparative). PTT polymer was prepared similar to the above example except the LiOH in the feed was replaced by sodium phosphite to achieve a concentration of about 18 ppm Na (24 ppm P) in the final polymer. The polymer strands and pellets during the pelletizing step were transparent, indicating little or no enhanced crystallization.

PTT with cobalt acetat (comparative). As noted in the control example, Co acetate has optionally been added to the PTT process. We have never observed enhanced crystallization of the strands or pellets during pelletizing when Co acetate was included at typical levels of 10-20 ppm Co.

DPG and cyclic dimer. The dipropylene glycol (DPG; bis(3-hydroxypropyl)ether) content of PTT prepared with LiOH and Na phosphite under reaction conditions described above wherein the PDO and TPA were added to PTT oligomer in the esterification stage as described above was measured by NMR (Table I). The DPG level was essentially the same for the samples made with or without LiOH or Na phosphite. The cyclic dimer content was also similar for all the samples.

TABLE I
Dipropylene Glycol and Cyclic Dimer Content in
0.92 Intrinsic Viscosity (IV) PTT

| | | | | Cyclic |
|---|---|---|---|---|
| | | DPG | DPG | dimer |
| Additive | IV | mole % | wt. % | wt. % |
| LiOH | 0.95 | 1.7 | 0.9 | 2.5 |
| none | 0.93 | 1.8 | 1.0 | 2.3 |
| Na phosphite | 0.93 | 1.4 | 0.8 | 2.3 |

DSC measurements. Samples were analyzed by differential scanning calorimetry DSC between room temperature and 270° C. The as-received pellets were heated at 10° C./min and then cooled at 50° C./min. In addition, smaller samples cut from the pellets were melted and cooled rapidly in ice water (“crash cooled”), dried at room temperature and then analyzed by heating at 10° C./min and cooling at 10° C./min.

Laboratory Preparations. A small scale lab reactor using the “zero heel” process in the absence of initial PTT oligomer (as described in U.S. Pat. No. 6,528,579, which is herein incorporated by reference) was charged with 315 gm PDO, 549 gm TPA and the additive and stirred and heated to 255-260° C. under 40 psi N₂ to distill out byproduct water. After about 2 hours, the pressure was reduced, Ti butoxide catalyst in 100 gm PDO (40 ppm Ti) was added, and the pressure was reduced further (prepolymerization stage) over about 30 minutes at 240-260° C. to about 3 mm Hg (absolute) or less. The polycondensation stage was continued under this vacuum at 255-260° C. for 80-120 minutes to distill out water and excess PDO to form PTT with IV of 0.6-0.8.

Results

Crystallinity. The crystallinity based on polymer density is shown in Table II for normal PTT and for PTT (IV˜0.92) prepared with about 7 ppm Li cation added as LiOH to the polymerization feed. The measurements were made on “as made” pellets from the reactor before being subjected to hot water crystallization and also after the crystallization step.

TABLE II
Crystallinity of All-Melt PTT (IV ˜0.92)

| | | After |
|---|---|---|
| | “As made” | crystallization |
| Normal PTT (control) | 10% | 29% |
| PTT with LiOH | 27% | 31% |

DSC Measurements. The polymers described above were analyzed by differential scanning calorimetry (see Experimental). The crystallization data during the cooling cycle in the DSC analysis is shown in the Table III where “T onset” is the temperature at which the exothermic crystallization began and “T max” is the temperature at which the peak of the crystallization exotherm occurred.

TABLE III
Differential Scanning Calorimetry
(PTT IV ˜0.92)

| | | |
|---|---|---|
| T, onset (° C.) | T, max (° C.) | ΔT (° C.) |

Whole pellet cooled at 50° C./min

| | | | |
|---|---|---|---|
| PTT with LiOH | 197 | 190 | 7 |
| PTT without LiOH | 165 | 132 | 33 |

Small sample cooled at 10° C./min

| | | | |
|---|---|---|---|
| PTT with LiOH | 205 | 200 | 5 |
| PTT without LiOH | 184 | 168 | 16 |

The PTT prepared with LiOH started crystallizing sooner, i.e. at significantly higher onset temperature during the cooling cycle, and the crystallization peak maximum also occurred at higher temperature. The difference between T (onset) and T (max) (ΔT) was only 7° C. for the sample made with LiOH and cooled at 50° C./min compared to □T=33° C. for the control sample. The higher crystallization temperatures, T (onset) and T (max), and the smaller □T indicates a much faster crystallization rate for the PTT made with LiOH. This result confirms the crystallization behavior observed during pelletizing.

The derivative heat flow (DH;: maximum of the slope of the crystallization peak) was measured in each analysis. For the measurements on the whole pellets cooled at 50° C./min, the DHF value was 178 for PTT made with LiOH and 8.2 for control, which indicates a crystallization rate about 21 times faster induced by Li. For the measurements on small samples cooled at 10° C./min, the DHF was 6.9 for PTT made with LiOH and 1.5 for the control, or about 4.6 times faster. Thus, the DHF analysis confirms the faster crystallization rate for PTT made with LiOH, as well.

Additional Examples. The DSC results on laboratory samples prepared with various additives (see Experimental) are shown in Table IV.

TABLE IV
Differential Scanning Calorimetry
(lab samples)

| | | | | | | |
|---|---|---|---|---|---|---|
| | | Additive | Metal | T, onset | T, max | ΔT |
| Additive | IV | ppm* | ppm* | (° C.) | (° C.) | (° C.) |

Cooling rate 50° C./min

| | | | | | | |
|---|---|---|---|---|---|---|
| LiOH H₂O | 0.65 | 42 | 7.1 | 191 | 184 | 7 |
| LiOH H₂O | 0.62 | 13 | 2.2 | 192 | 187 | 5 |
| LiAc 2H₂O | 0.69 | 41 | 2.8 | 193 | 186 | 7 |
| LiAc 2H₂O | 0.72 | 13 | 0.9 | 172 | 136 | 36 |
| Ca(OH)₂ | 0.73 | 14 | 7.5 | 185 | 178 | 7 |
| NaOH | 0.69 | 13 | 7.6 | 166 | 155 | 11 |
| NaAc 3H₂O | 0.78 | 41 | 6.8 | 167 | 158 | 9 |
| Co(Ac)₂ 4H₂O | 0.73 | 13 | 3.0 | 156 | 135 | 21 |
| none | 0.91 | | | 166 | 113 | 53 |
| none | 0.82 | | | 162 | 128 | 33 |
| none | 0.70 | | | 168 | 125 | 43 |

Cooling rate 10° C./min

| | | | | | | |
|---|---|---|---|---|---|---|
| LiOH H₂O | 0.65 | 42 | 7.1 | 203 | 200 | 3 |
| LiOH H₂O | 0.62 | 13 | 2.2 | 203 | 199 | 4 |
| LiAc 2H₂O | 0.69 | 41 | 2.8 | 202 | 198 | 4 |
| LiAc 2H₂O | 0.72 | 13 | 0.9 | 191 | 172 | 19 |
| Ca(OH)₂ | 0.73 | 14 | 7.5 | 195 | 192 | 3 |
| NaOH | 0.69 | 13 | 7.6 | 191 | 176 | 15 |
| NaAc 3H₂O | 0.78 | 41 | 6.8 | 180 | 172 | 8 |
| Co(Ac)₂ 4H₂O | 0.73 | 13 | 3.0 | 178 | 163 | 15 |

*Based on theoretical yield of PTT polymer.
Ac = acetate

These examples show that LiOH enhances the crystallization rate even at about 2 ppm Li. Li acetate shows a similar enhancement at about 3 ppm Li but less effect at about 1 ppm Li. Calcium hydroxide also showed a rate enhancement. Sodium hydroxide appears to induce a smaller effect, particularly on T(max) and □T, and cobalt acetate did not show enhanced crystallization at the concentrations used.

Discussion

The PTT polymers described here include crystallizable polyesters with 3-hydroxypropyl endgroups, especially PTT homopolymer and copolymers comprised of 80 mole % or more of backbone units derived from 1,3-propanediol based on total diols. Because comonomers, both glycols and diacids, can decrease or inhibit crystallinity or crystallization, the compositions described are most applicable to PTT polymers comprised of high amounts of trimethylene glycol units and terephthalate units.

In the context used here, rapid crystallization is achieved typically when, upon cooling the polymer melt at a rate of 50° C. per minute, the temperature at which onset of crystallization begins is higher, typically 5° C. or more higher, than the onset temperature for the corresponding PTT polymer prepared without the cations, and/or when the temperature at the maximum of the exothermic crystallization peak is higher, typically 5° C. or more higher, than the crystallization temperature at maximum exotherm for the corresponding PTT polymer prepared without the metal cations.

Another characteristic of the rapid-crystallizing PTT compositions described herein is the difference between the crystallization onset temperature, described above, and the maximum exotherm temperature, also described above. This difference between these temperatures or □T is smaller for rapid-crystallizing PTT compared to the □T for the corresponding PTT polymer prepared without the metal cations. The □T is affected by the cooling rate, generally being larger at fast cooling rates, e.g. 50° C./min., than at slower cooling rates, e.g. 10° C./min.

This report discloses a convenient and efficient process for preparing the said rapid-crystallizing PTT wherein the metal salt, preferably derived from a weak conjugate acid, such as water or acetic acid, that is less acidic (higher pKa) than terephthalic acid and/or volatile under the reaction conditions, is added to the polymerization process, preferably in the feed or first esterification stage. Preferred alkali or alkaline earth metal salts are those of lithium and calcium, including lithium hydroxide, lithium acetate, calcium hydroxide, and the like.

The amount of the metal salt, including the preferred alkali or alkaline earth metal salts, added to the polymerization process or contained in the final polymer is from about 0.01 to about 200 ppm by weight based on the metal cation (M), preferably from 0.1 to 100 ppm of M, and most preferably from 1 to 50 ppm. Higher amounts of the metal cation in excess over the amounts stated above may be used, although the excess cation concentration may have relatively little or no additional impact on the crystallization rate and, in some cases, may be detrimental to the other properties or performance of the polymer. The amount of metal cation added may vary depending on the metal used and the desired degree of enhanced crystallization rate or desired degree of crystallization of the product. Typically, significantly lower concentrations of lithium or calcium cations are needed compared to the other metal cations.

It is interesting to note that the typical levels of Li or Ca (2-7 ppm) in the examples shown here correspond to about 0.1 to 1 milliequivalent per kilogram polymer, which is far less than the typical carboxylic acid (COOH) endgroup content in PTT of 5-30 meq/Kg, most typically 10-20 meq/Kg. It is reasonable to conclude that the compositions we describe are comprised of COOM endgroups from partial or complete conversion of the COOH polymer endgroups. The most effective levels of the metal salts (M), particularly Li and Ca salts, will be in the range of about 0.1 to 30 meq/Kg, preferably 0.2 to about 10 meq/Kg. Once the number of metal cations exceeds the number of COOH endgroups, most or all of the COOH endgroups will be converted to COOM endgroups, so higher amounts of the metal cation will have relatively smaller incremental effect on the crystallization rates.

In the case of PTT polymers incorporating other glycols or diacids, the amount of metal cation may need to be increased to achieve the desired enhanced crystallization rate compared to PTT prepared from only 1,3-propanediol and terephthalic acid or dialkyl terephthalate, i.e. more metal cation may be needed to overcome the effects of the comonomer units on crystallization. In some cases, the comonomers may suppress crystallization so much that rapid crystallization, as defined herein, cannot be achieved. Even for PTT prepared from 1,3-propanediol and terephthalic acid, the polymer usually is comprised of dipropylene glycol units (DPG; bis(3-hydroxypropyl)ether). The amount of DPG units can vary, depending on the process conditions, from 0.05 to about 5 mole % or more based on total diol, typically from 0.1 to 3 mole %. The effectiveness of the metal cation on crystallization will be greater for those compositions with relatively low DPG content compared to those with higher DPG content. We believe that DPG inhibition is not expected with the above described all-melt system experiments because esterification was executed with a heel process. This process utilizes a heel of the previous esterification product batch in the esterification reactor, affording faster solvation and reaction of the TPA. In a zero heel system, solvation is not as consistent and thus high relative concentrations of the free acid can catalyze the formation of DPG and acrolein. The additives named in this application and the zero heel PTT process patent discussed above inhibit the undesired DPG formation and also serve to increase crystallinity of the product.

The enhancement of crystallization for the PTT compositions and processes may be somewhat more effective at higher IV's of the melt product during the pelletizing step. Under these conditions, the amount of alkali or alkaline earth metal cation required to achieve a desired degree of crystallization may be less in the case of melt polymer with, for example, an IV>0.8, and more metal cation may be needed for melt polymer prepared with lower IVs.

Another aspect of the processes described herein is a continuous, semi-batch or batch process in which the crystallization step in the process is eliminated or conducted under milder conditions. This crystallization step typically requires heating the polymer pellets above the glass transition temperature, typically at >70° C. for PTT containing 0.05 to 3 mole % DPG units, for a period of time in water or under air or inert atmosphere. Milder crystallization conditions can include reducing the residence or contact time during the crystallization step and/or lowering the crystallization temperature, e.g. from 80-95° C. to 70-75° C. for hot water crystallization during underwater pelletization.

A further aspect is the preparation of a solid-stated PTT that exhibits less friability, i.e. less subject to fracture and/or dust formation, in which the rapid-crystallizing PTT composition with an IV of about 0.4 or more is prepared, pelletized and the rapidly crystallizable pellets, with or without a separate crystallization step, are then subjected to solid-state polymerization at 180-225° C. under vacuum or flow of inert gas for a time sufficient to reach the desired final IV greater than 0.8.

1. A process for increasing the crystallization rate of polytrimethylene terephthalate which comprises adding small amounts of one or more alkali or alkaline earth metal salts to polytrimethylene terephthalate.

2. The process of claim 1 wherein the metal is lithium or calcium.

3. The process of claim 1 wherein the amount of the alkali or alkaline earth metal, based on metal, is from about 0.01 to about 200 ppm.

4. The process of claim 1 wherein the salts are carboxylate salts.

5. The process of claim 1 wherein the metal salt is added during the process of polymerization of polytrimethylene terephthalate.

6. A fast-crystallizing polytrimethylene terephthalate composition which comprises polytrimethylene terephthalate with carboxylate salt endgroups, COOM, wherein M is an alkali or alkaline earth metal cation.
